(19) United States
(12) Patent Application Publication
(10) Pub. No.: US 2010/0244648 A1
(43) Pub. Date: Sep. 30, 2010

(54) LED LIGHTING LAMP

(75) Inventor: Young Ho Yoo, Goyang-si (KR)

Correspondence Address: CANTOR COLBURN, LLP, 20 Church Street, 22nd Floor, Hartford, CT, 06103, US

(73) Assignee: FAWOO TECHNOLOGY CO., LTD., Bucheon (KR)

(21) Appl. No.: 12/738,761

(22) PCT Filed: Oct. 17, 2008
(86) PCT No.: PCT/KR08/06131

§ 371 Date: Apr. 19, 2010

(30) Foreign Application Priority Data
Oct. 26, 2007 (KR) 10-2007-0108412

(51) Int. Cl. H01J 61/52

(52) U.S. Cl. 313/46

(57) ABSTRACT

Disclosed herein is a Light Emitting Diode (LED) lighting lamp, which is coupled with the threadedly coupled receptacle of a vertically mounted post lamp support. The LED lighting lamp includes a light source unit, a heat sink means, and a housing. The light source unit includes one or more LEDs and a PCB. The heat sink means is bonded to the PCB to radiate heat from the light source unit. The housing is configured to support the heat sink means, and to have a threadedly coupled power source connection part. In the LED lighting lamp, the LEDs of the light source unit are supported by and disposed on the heat sink means so that light beams from the LEDs are emitted at a predetermined downward inclination angle.

### TECHNICAL FIELD

The present invention relates to a Light Emitting Diode (LED) lighting lamp which is mounted to a threadedly coupled receptacle, vertically mounted, so as to enable light beams to be emitted from LEDs at a predetermined downward inclination angle, thus remarkably increasing effective light efficiency by minimizing the loss of light, and which enables the surrounding landscape to be extensively illuminated from the upper zone to the bottom, thus remarkably improving the quality of night illumination in outdoor facilities, such as parks, by removing unilluminated spots.

### BACKGROUND ART

When compared with a conventional light source, an LED not only has a longer life span, but also has superior energy efficiency because electrical energy is directly converted into light energy and, thus, less power is consumed. In addition, such an LED has high light intensity and high-speed response characteristics. Accordingly, various lighting devices ranging from typical home lighting devices to outdoor lighting devices, such as streetlamps and park lamps, have been developed using such LEDs as light sources.

Furthermore, as shown in FIG. 9, a conventional outdoor facility lighting device installed in a park or an amusement park is configured such that a lamp support 3 is mounted on a post 2 that is planted on the ground, and such that a threadedly coupled receptacle 3a is provided in the lamp support 3 to vertically mount a lighting lamp 100.

In the conventional lighting device, described above, the lighting lamp 100 is vertically mounted to the threadedly coupled receptacle 3a, and thus the upper zone of the surroundings can be extensively illuminated. However, a problem occurs in that the lower zone of the surroundings becomes a dark unilluminated zone because no light reaches the lower zone.

In order to solve this problem, a reflection mirror is mounted over the lighting lamp as needed. However, in this case, problems occur in that lighting efficiency is lowered, in that a large space is required because the size of the device is increased, and in that the manufacturing cost is increased.

Furthermore, a technology in which the attachment surface of a Printed Circuit Board (PCB) is formed to have a rectangular pillar shape so as to enable light beams to be horizontally emitted from the circumference of the PCB has been disclosed. However, in this case, problems occur in that the lower unilluminated zone still remains because light beams are merely horizontally propagated, and in that effective light efficiency is low.

### DISCLOSURE OF INVENTION

### Technical Problem

Accordingly, the present invention has been made keeping in mind the above problems occurring in the prior art, and an object of the present invention is to provide an LED lighting lamp which is mounted to a threadedly coupled receptacle so as to enable light beams to be emitted from LEDs at a predetermined downward inclination angle, thus remarkably increasing effective light efficiency by minimizing the loss of light, and which enables the surrounding landscape to be extensively illuminated from the upper zone to the bottom, thus remarkably improving the quality of night illumination in outdoor facilities, such as parks, by removing unilluminated spots.

### Technical Solution

In order to accomplish the above object, the present invention provides an LED lighting lamp, which is coupled with the threadedly coupled receptacle of a vertically mounted post lamp support, the LED lighting lamp including: a light source unit comprising one or more LEDs and a PCB; a heat sink means bonded to the PCB to radiate heat from the light source unit; and a housing configured to support the heat sink means, and to have a threadedly coupled power source connection part, wherein the LEDs of the light source unit are supported by and disposed on the heat sink means so that light beams from the LEDs are emitted at a predetermined downward inclination angle.

### ADVANTAGEOUS EFFECTS

The LED lighting lamp according to the present invention, which is constructed as described above, is mounted to the threadedly coupled receptacle, vertically mounted, so as to enable light beams to be emitted from the LEDs at a predetermined downward inclination angle, thus remarkably increasing effective light efficiency by minimizing the loss of light. Furthermore, the LED lighting lamp according to the present invention enables the surrounding landscape to be extensively illuminated from the upper zone to the bottom, thus remarkably improving the quality of night illumination in outdoor facilities, such as parks, by removing unilluminated spots.

### BRIEF DESCRIPTION OF THE DRAWINGS

FIG. 1 is a dissembled sectional view showing the construction of an LED lighting lamp according to an embodiment of the present invention;

FIG. 2 is an assembled view of FIG. 1;

FIG. 3 is a plan view of FIG. 1;

FIG. 4 is a development view of a PCB according to an embodiment of the present invention;

FIG. 5 is a perspective view of a heat sink means according to an embodiment of the present invention;

FIG. 6 is a view showing the construction of an LED lighting lamp according to another embodiment of the present invention;

FIG. 7 is a view showing the construction of an LED lighting lamp according to another embodiment of the present invention;

FIG. 8 is a view showing the installation of FIG. 1; and

FIG. 9 is a view showing the construction of a conventional lighting device.

### DESCRIPTION OF CHARACTERS OF PRINCIPAL ELEMENTS

1: park LED lamp according to the present invention
10: light source unit 11: LED
13: PCB 30: heat sink means
31: body 312: seating part
314: cover mounting groove
316: heat sink pin mounting part
40: power supply control unit
41: temperature sensor 50: housing
51: power source connection part
60: transparent cover 70: lamp support
71: pillar part
75: housing cover part
2; post 3: post lamp support
3a: threadedly coupled receptacle

### MODE FOR THE INVENTION

LED lighting lamps according to embodiments of the present invention are described in detail with reference to the accompanying drawings below.

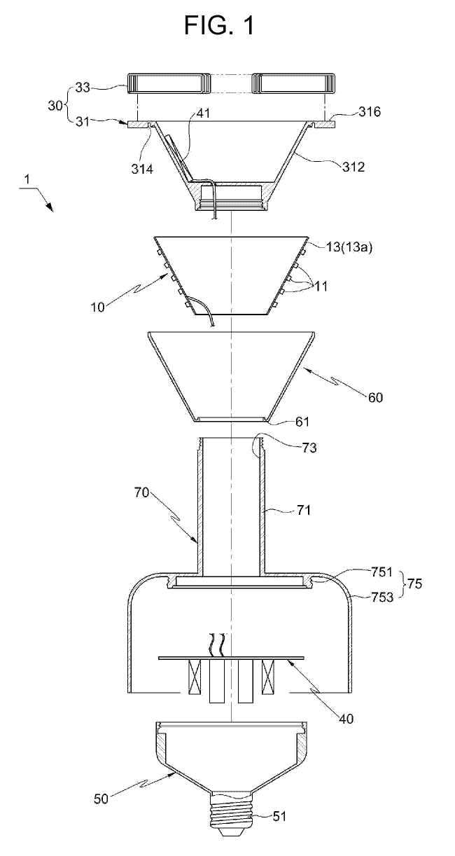

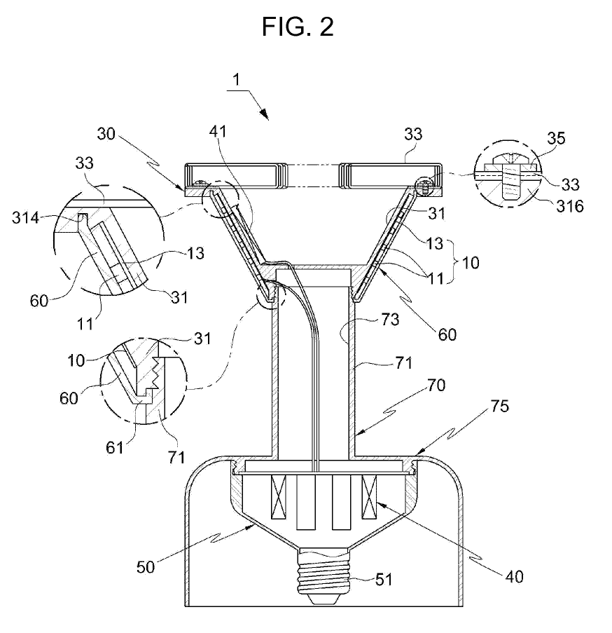

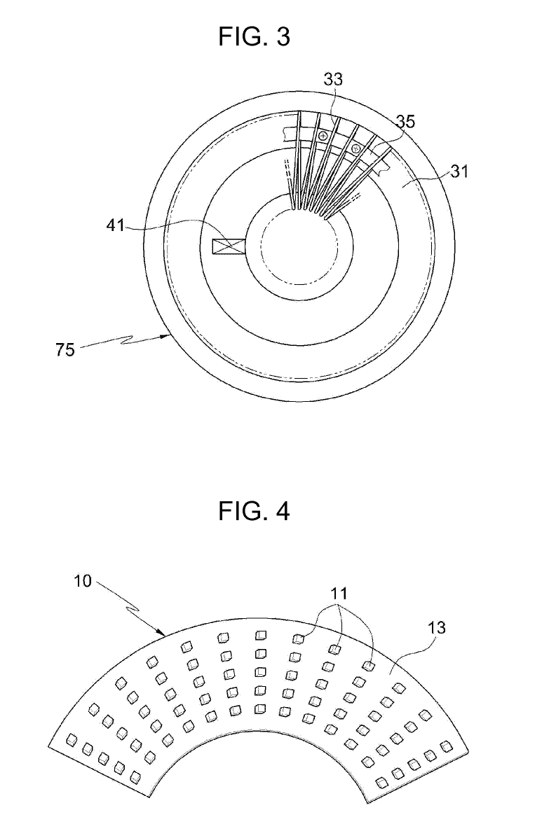

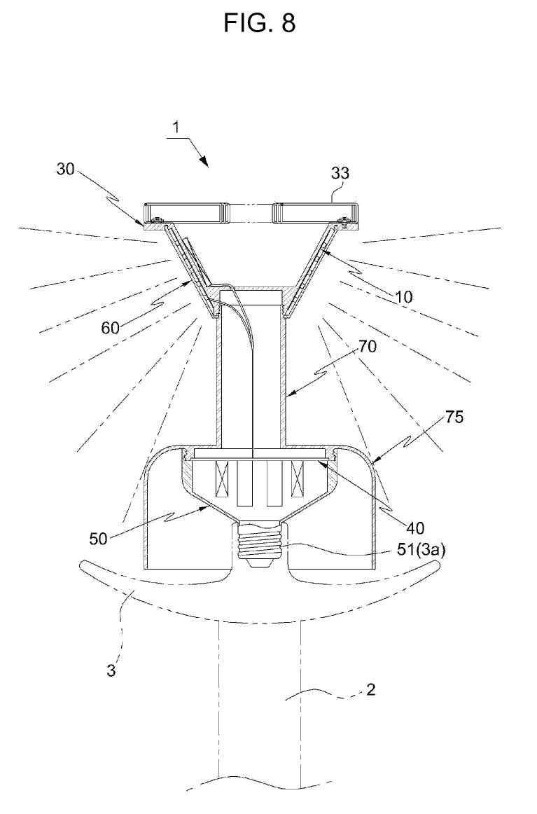

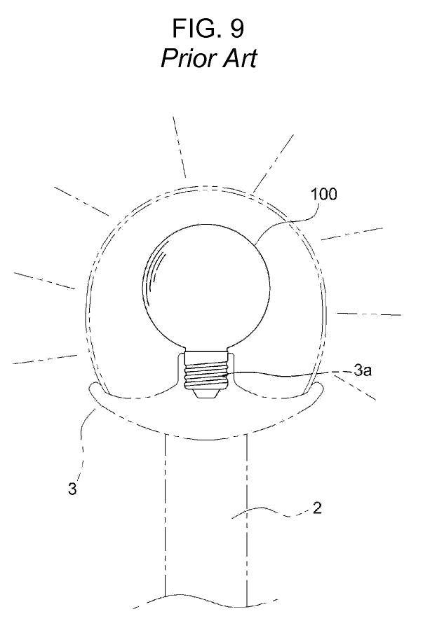

FIG. 1 is a dissembled sectional view showing the construction of an LED lighting lamp according to an embodiment of the present invention, FIG. 2 is an assembled view of FIG. 1, FIG. 3 is a plan view of FIG. 1, and FIG. 8 is a view showing the installation of FIG. 1.

As shown in FIGS. 1 to 3 and in FIG. 8, the LED lighting lamp 1 according to the present embodiment is coupled with a threadedly coupled receptacle 3a of a vertically mounted post lamp support 3, and includes a light source unit 10 having one or more LEDs 11 and a PCB 13, a heat sink means 30 bonded to the PCB 13 to radiate heat from the light source unit 10, and a housing 50 configured to support the heat sink means 30, and to have a threadedly coupled power source connection part 51. In the present embodiment, the LEDs 11 of the light source unit 10 are supported by and disposed on the heat sink means 30 so that light beams from the LEDs 11 are emitted at a predetermined downward inclination angle.

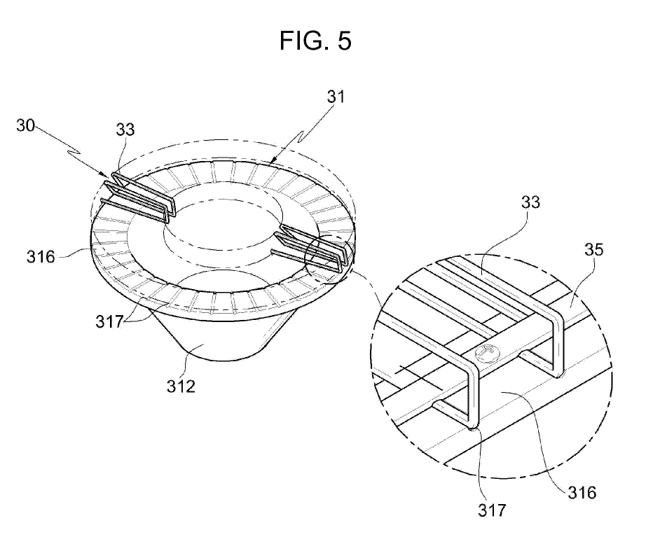

The light source unit 10 is configured such that the PCB 13, which is a Flexible PCB (FPCB), is formed to have a funnel shape, and the LEDs 11 are mounted such that the light beams are emitted at the predetermined downward inclination angle without being oriented to the housing 50. It is preferred that the heat sink means 30 include a funnel-shaped body 31, which corresponds to the funnel-shaped PCB 13a so that the funnel-shaped PCB 13a is seated on an outer circumferential surface of the funnel-shaped body 31 (refer to FIG. 5).

As shown in FIG. 4, the light source unit 10 is configured such that the flexible PCB 13, which is formed to have a fan shape, is attached to the body 31 of the heat sink means 30.

Furthermore, the heat sink means 30 is configured by coupling a coil-type heat sink pin 33 to the body 31. It is preferred that the coil-type heat sink pin 33 be formed to have a rectangular or circular coil shape by continuously winding a wire in a rectangular or circular form, or that the coil-type heat sink pin 33 be formed by continuously arranging individual ring coils (not shown), having rectangular or circular shapes.

The coil-type heat sink pin 33 is formed to have a very large heat radiating surface area, by which the air lock phenomenon is prevented, thus rapidly radiating the heat generated from the light source unit 10 under an environment in which a natural draft is made.

Furthermore, in the heat sink means 30, it is preferred that a cover mounting groove 314, in which a transparent cover 60 for protecting the light source unit 10 is mounted, be formed in the lower surface of the heat sink pin mounting part 316 of the body 31.

The funnel-shaped heat sink means 30 may be configured such that the coil-type heat sink pin mounting part 316, on which the coil-type heat sink pin 33 is mounted, is formed to have a flange shape at the upper end of the body 31.

The coil-type heat sink pin 33 may be fastened in such a way that insertion grooves 317 are formed in the heat sink pin mounting part 316 according to the disposition of the coil-type heat sink pin 33, and a holder 35 is inserted into the coil-type heat sink pin 33 so as to be located opposite the insertion grooves 317 and fastened using bolts (refer to FIG. 5).

Furthermore, the heat sink means 30 is coupled with a temperature sensor 41 that operates in conjunction with a power supply control unit 40.

Furthermore, the LED lighting lamp 1 according to the present embodiment includes a lamp support 70, which is mounted between the housing 50 and the heat sink means 30 so that the light source unit 10 is spaced apart from the housing 50 by a predetermined length, and which is provided with a pillar part 71, in which an electric wire path 73 is formed, and a housing cover part 75.

It is preferred that the lamp support 70 be configured such that the outer surface thereof is coated with material that reflects light. In this embodiment, the coating material may be chromium.

Furthermore, the transparent cover 60 may be configured such that the upper end thereof is inserted into the cover mounting groove 314, and such that the lower end thereof is fastened to the lamp support 70, which is coupled with the body 31 of the heat sink means 30 in a fitting manner.

The lamp support 70 is configured such that a screw part 751 for coupling with the housing 50 is formed in the housing cover part 75, and such that a skirt part 753 having a heat radiating function is formed in the housing cover part 75 to surround the housing 50. It is preferred that the lamp support 70 be threadedly coupled with the body 31 of the heat sink means 30.

Next will be described the installation and operation of the LED lighting lamp 1 according to the present embodiment, constructed as described above.

The core concept of the present embodiment is that the post lamp support 3 and the threadedly coupled receptacle 3a are vertically mounted under the LED lighting lamp 1 to a post 2 used to mount park lamps. A further concept is to mount the light source unit 10 so that the LEDs 11 of the light source unit 10 emit light beams above the post 2 at a predetermined downward inclination angle.

That is, the LEDs 11 are slantingly mounted over the housing 50, which is coupled to the threadedly coupled receptacle 3a.

In the present embodiment, the body 31 of the heat sink means 30 is formed to have a funnel shape, and the flexible PCB 13, to which the LEDs 11 are mounted, is seated on the outer circumferential surface of the body 31 so that the LEDs 11 mounted to the flexible PCB 13 can emit light beams at the predetermined downward inclination angle. In this case, the funnel-shaped body 31 of the heat sink means 30 and the PCB 13 are configured to be inclined at a predetermined angle so that light beams from the LEDs 11 are not oriented to the housing 50. Accordingly, the loss of light that occurs when the light beams from the LEDs 11 are interrupted by the housing 50 can be reduced, and thus effective light efficiency can be maximized.

Furthermore, the lamp support 70 causes the light source unit 10 to be spaced apart from the housing 50 by the length of the pillar part 71, so that the loss of light, attributable to the housing 50, can be reduced even though the funnel radius of the heat sink means body 31 and the funnel radius of the PCB 13 are not increased.

Furthermore, the coil-type heat sink pin 33 is formed to have a very large heat radiating surface area, thus remarkably improving the heat radiating performance. Accordingly, the heat radiation caused by turning on a high-power LED lighting lamp having a high thermal load can be uninterruptedly performed without requiring that any air blowing fan is used.

Meanwhile, the power supply control unit 40, which operates in conjunction with the temperature sensor 41 attached and mounted to the heat sink means body 31, performs control so that the supply of power to the light source unit 10 is automatically interrupted to protect the light source unit 10 when the temperature of the heat sink means 30 is equal to or greater than a predetermined temperature, and so that power is supplied again to the light source unit 10 when the temperature of the heat sink means becomes lower than the predetermined temperature.

As described above, the present embodiment is mounted to the threadedly coupled receptacle, which is vertically mounted, so as to enable the LEDs 11 to emit light beams at a predetermined downward inclination angle, thus remarkably increasing effective light efficiency by minimizing the loss of light. Furthermore, the present embodiment enables the surrounding landscape to be extensively illuminated from the upper zone to the bottom, thus remarkably improving the quality of night illumination in outdoor facilities, such as parks, by removing unilluminated spots.

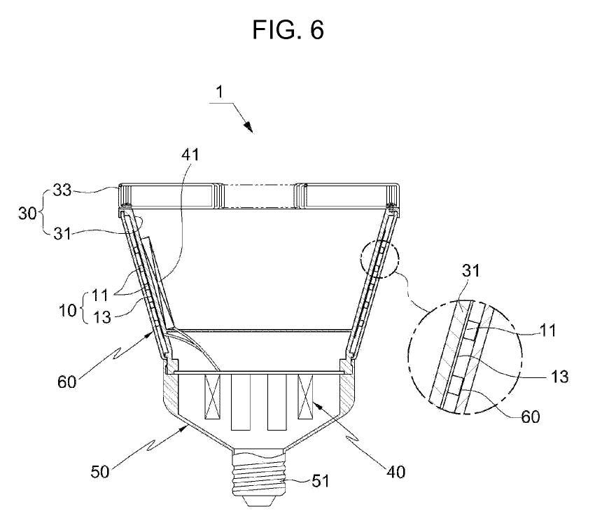

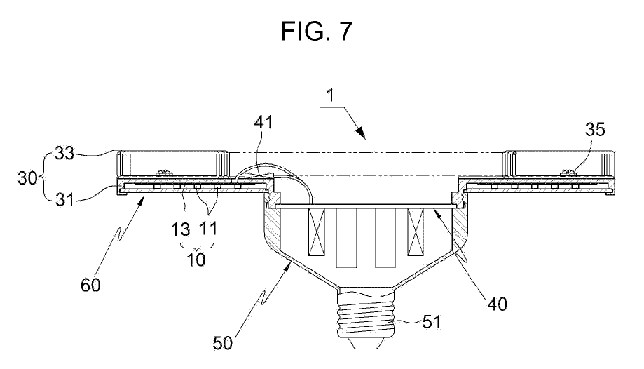

In another embodiment of the present invention, the heat sink means 30 may be directly coupled to the housing 50 without requiring that any lamp support is used, as shown in FIG. 6.

Furthermore, in another embodiment of the present invention, the PCB 13 and the body 31 of the heat sink means 30 may be formed parallel to each other. The LEDs 11 may be mounted so as to emit light beams downwards.

The preferred embodiments of the present invention have been described above with reference to the accompanying drawings. Here, it must be understood that the terms or words used in the specification and claims of the present invention should not necessarily be understood according to their general meanings or dictionary definitions, but should be understood to have meanings and to represent concepts conforming to the technical spirit of the present invention. Accordingly, the embodiments, which are described in the specification, and the constructions, which are shown in the drawings, are merely the most preferred embodiments of the present invention, and do not represent all of the technical spirits of the prevent invention, so that it should be understood that there may be various equivalents to replace the embodiments at the time of this application.

### INDUSTRIAL APPLICABILITY

The LED lighting lamp according to the present invention, which is constructed as described above, is mounted to the threadedly coupled receptacle, which is vertically mounted, so as to enable light beams to be emitted from the LEDs at a predetermined downward inclination angle, thus remarkably increasing effective light efficiency by minimizing the loss of light. Furthermore, the LED lighting lamp according to the present invention enables the surrounding landscape to be extensively illuminated from the upper zone to the bottom, thus remarkably improving the quality of night illumination in outdoor facilities, such as parks, by removing unilluminated spots.

1. A Light Emitting Diode (LED) lighting lamp, which is coupled with a threadedly coupled receptacle of a vertically mounted post lamp support, the LED lighting lamp comprising:
a light source unit comprising one or more LEDs and a Printed Circuit Board (PCB);
heat sink means bonded to the PCB to radiate heat from the light source unit; and
a housing configured to support the heat sink means, and to have a threadedly coupled power source connection part,
wherein the LEDs of the light source unit are supported by and disposed on the heat sink means so that light beams from the LEDs are emitted at a predetermined downward inclination angle.

2. The LED lighting lamp according to claim 1, wherein the light source unit is configured such that the PCB, which is a Flexible PCB (FPCB), is formed to have a funnel shape, and the LEDs are mounted such that the light beams are emitted at the predetermined downward inclination angle without being oriented to the housing; and the heat sink means comprises a funnel-shaped body, which corresponds to the funnel-shaped PCB so that the funnel-shaped PCB is seated on an outer circumferential surface of the funnel-shaped body.

3. The LED lighting lamp according to claim 2, wherein the heat sink means is configured by coupling a coil-type heat sink pin to the body, the coil-type heat sink pin being formed to have a rectangular or circular coil shape by continuously winding a wire in a rectangular or circular form or being formed by continuously arranging individual ring coils that have rectangular or circular shapes.

4. The LED lighting lamp according to claim 2, wherein the heat sink means is configured such that a cover mounting groove, in which a transparent cover for protecting the light source unit is mounted, is formed in a lower surface of a heat sink pin mounting part of the body.

5. The LED lighting lamp according to claim 3, wherein the heat sink means is configured such that a coil-type heat sink pin mounting part is formed to have a flange shape at an upper end of the body.

6. The LED lighting lamp according to claim 1, wherein the heat sink means is coupled with a temperature sensor that operates in conjunction with a power supply control unit.

7. The LED lighting lamp according to claim 1, further comprising: a lamp support, which is mounted between the housing and the heat sink means so that the light source unit is spaced apart from the housing by a predetermined length, and which is provided with a pillar part, in which an electric wire path is formed, and a housing cover part.

8. The LED lighting lamp according to claim 7, wherein the lamp support is configured such that an outer surface thereof is coated with material that reflects light.

9. The LED lighting lamp according to claim 4, wherein the transparent cover is configured such that an upper end thereof is inserted into the cover mounting groove and such that a lower end thereof is fastened to a lamp support, which is coupled with the body of the heat sink means in a fitting manner.
